(19) United States
(12) Patent Application Publication
(10) Pub. No.: US 2004/0255564 A1
(43) Pub. Date: Dec. 23, 2004

(54) Combination landscaping and herbicide spraying device

(76) Inventor: Francisco B. Loaces, Concord, NC (US)

Correspondence Address: Adams Evans P.A., 2180 Two Wachovia Center, 301 S. Tryon Street, Charlotte, NC, 28282, US

(21) Appl. No.: 10/872,284

(22) Filed: Jun. 18, 2004

Related U.S. Application Data
(60) Provisional application No. 60/479,750, filed on Jun. 19, 2003.

(51) Int. Cl. A01D 34/00

(52) U.S. Cl. 56/12.7

(57) ABSTRACT

A lawn maintenance and liquid dispensing apparatus includes a motorized lawn maintenance tool, with a connected spraying device for spraying a liquid, such as a pesticide, herbicide, or other agricultural liquid composition. The spraying device includes a container for holding the liquid and a nozzle for spraying the liquid. The nozzle is positioned at an angle so that the liquid dispensed from the nozzle is directed away from the apparatus. The container is connected to the nozzle by a fluid line. The container is positioned proximate a handle that is located on the upper portion of the apparatus, while the nozzle is positioned proximate the lower end of the nozzle.

### TECHNICAL FIELD AND BACKGROUND OF THE INVENTION

This application claims the benefit of U.S. Provisional Application No. 60/479,750, filed Jun. 19, 2003.

The invention relates to an apparatus that can perform lawn maintenance functions such as weed trimming, edging, and blowing, and also dispense a liquid composition such as a pesticide. The invention is particularly suited for large landscaping projects that require a worker to cover long distances. The invention combines the function of a motorized lawn maintenance tool, such as a weed trimmer, edger or leaf blower, with the related function of dispensing pesticide, thereby eliminating the need for the worker to make two trips over the same area.

The invention is a new landscaping apparatus that comprises a sprayer attachment on a landscaping tool, such as an edger or weed trimmer. The sprayer attachment sprays a herbicide or pesticide, such as ROUNDUP weed killer, while the lawn maintenance tool simultaneously cuts weeds or edges.

Motorized weed trimmers and edgers, powered by gas or electricity, are a commonly used tool in lawn maintenance projects. In addition, the use of pesticides, such as herbicides, fungicides and insecticides, are commonly used to eliminate and prevent unwanted vegetation and insects. A landscaper will often use a weed trimmer or edger in a certain area, and then have to return to the same area to dispense pesticide using a separate spraying apparatus. Typically, this requires the landscaper to perform the trimming or edging, return the trimmer or edger to a truck or other location where the pesticide dispensing equipment is retrieved, and then travel along the same area again with the pesticide dispensing equipment. The fact that weed trimming and edging duties often require commercial landscapers to walk significant distances exacerbates the inconvenience and inefficiency created by having to travel the same area twice to trim and spray pesticide.

### SUMMARY OF THE INVENTION

Therefore it is an object of the present invention to provide a lawn maintenance apparatus that is capable of performing weed trimming or edging functions, and can also disperse liquid pesticides, such as herbicide, fungicide and insecticide.

Another object of the present invention is to provide an apparatus having a nozzle for dispersing the pesticide that is positioned such that the pesticide is dispensed in a direction away from the head of the trimmer or edger.

These and other objectives of the present invention are achieved by providing an apparatus for lawn maintenance and dispensing a liquid that includes a motorized lawn maintenance tool, which has an arm having first and second ends and a head piece connected proximate the first end of the arm. A spraying device is connected to the arm for spraying a liquid, the spraying device includes a container for holding the liquid and a nozzle for spraying the liquid. The nozzle is positioned at an angle relative to the arm so that the liquid dispensed from the nozzle is directed away from the head piece.

According to a preferred embodiment of the invention, the motorized lawn maintenance tool is a weed trimmer, edger or leaf blower.

According to a preferred embodiment of the invention, the weed trimmer includes a rotatable string for trimming vegetation.

According to another preferred embodiment of the invention, the liquid exiting the nozzle avoids contacting the string.

According to yet another preferred embodiment of the invention, the invention includes a motor for driving the weed trimmer or edger.

According to yet another preferred embodiment of the invention, the arm is bent wherein the arm is ergonomically formed to define a bow shape.

According to yet another preferred embodiment of the invention, a handle is connected to the arm and positioned proximate the second end of the arm.

According to yet another preferred embodiment of the invention, the container is positioned proximate the handle, and the nozzle is positioned proximate the first end of the arm.

According to yet another preferred embodiment of the invention, the liquid comprises a pesticide.

According to yet another preferred embodiment of the invention, the nozzle is positioned at an angle of 100 to 120 degrees relative to the arm.

According to yet another preferred embodiment of the invention, the apparatus is manually rotatable between a lawn maintenance mode in which the weed trimmer or edger is in operation and a liquid dispensing mode with the liquid being sprayed from the nozzle.

According to yet another preferred embodiment of the invention, the apparatus is rotated approximately 180 degrees when rotated between the lawn maintenance mode and the liquid dispensing mode.

According to yet another preferred embodiment of the invention, a trigger is operatively connected to a valve positioned in the fluid line whereby pressing the trigger opens the valve to allow the liquid to pass through the fluid line.

According to yet another preferred embodiment of the invention, a trigger guard is positioned over the trigger for positioning a finger of a user when rotating the lawn maintenance apparatus from the lawn maintenance mode to the liquid dispensing mode so that unintentional spraying of the liquid is prevented.

According to yet another preferred embodiment of the invention the spraying device includes a pump connected to the container for pressurizing the container, and a fluid line connected to the container and the nozzle. The liquid in the container is delivered through the fluid line and exits the nozzle. As such, the nozzle is positionable proximate the first end of the arm and the container is positionable proximate the second end of the arm.

A preferred embodiment of the method of lawn maintenance according to the invention includes providing an apparatus having a lawn maintenance tool that includes an arm having first and second ends and a head piece connected proximate the first end of the arm, and a spraying device connected to the arm for spraying a liquid. The spraying device includes a nozzle positioned at an angle relative to the arm, and the nozzle is positioned at an angle relative to the arm so that liquid dispensed from the nozzle is directed away from the head piece. The apparatus is operable in a lawn maintenance mode with the lawn maintenance tool in operation and a liquid dispensing mode with the liquid being sprayed from the nozzle. The apparatus is rotatable between a first position for operation in the lawn maintenance mode and a second position for operation in the liquid dispensing mode. The lawn maintenance apparatus is operated in the lawn maintenance mode in which the lawn maintenance tool is utilized to perform a desired lawn maintenance function. The lawn maintenance apparatus is rotated from the first position to the second position, and operated in the liquid dispensing mode in which liquid is dispensed at a desired location.

In another preferred embodiment of the method of lawn maintenance according to the invention, the apparatus comprises a trigger operatively connected to the nozzle so that pressing the trigger actuates the flow of the liquid through the nozzle. A trigger guard is positioned over the trigger, and the user positions his finger on the trigger guard when rotating the lawn maintenance apparatus from the first position to the second position so that unintentional spraying of the liquid is prevented.

In another preferred embodiment of the method of lawn maintenance according to the invention, the apparatus is rotated approximately 180 degrees between the first position and the second position.

In another preferred embodiment of the method of lawn maintenance according to the invention, the lawn maintenance tool is a weed trimmer, and the step of operating the lawn maintenance apparatus in the lawn maintenance mode includes cutting away unwanted vegetation.

The invention substantially increases efficiency for lawn maintenance operations by enabling the user to cut weeds or edge and spray herbicide or pesticide simultaneously. As such, work time is generally cut in half as the user need not travel twice over the same lawn maintenance route as in prior operations that require workers to cut weeds or edge separately from spraying. The invention enables the user to accomplish in one trip what previously required two.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a partial cross-sectional view of a lawn maintenance and liquid dispensing apparatus according to a preferred embodiment of the invention;

FIG. 2 is an environmental view of the lawn maintenance and liquid dispensing apparatus of FIG. 1;

FIG. 3 is another environmental view of the lawn maintenance and liquid dispensing apparatus of FIG. 1;

FIG. 4 is an environmental view of a lawn maintenance and liquid dispensing apparatus according to another preferred embodiment of the invention;

FIG. 5 is another environmental view of the lawn maintenance and liquid dispensing apparatus of FIG. 4;

FIG. 6 is an environmental view of a lawn maintenance and liquid dispensing apparatus according to yet another preferred embodiment of the invention; and

FIG. 7 is another environmental view of the lawn maintenance and liquid dispensing apparatus of FIG. 6.

### DETAILED DESCRIPTION OF THE INVENTION

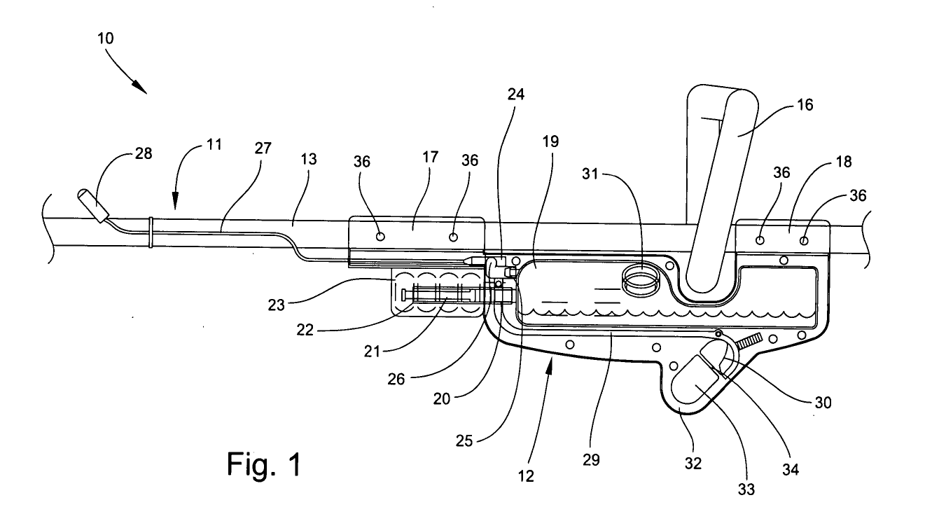

Referring now specifically to the drawings, a lawn maintenance and liquid dispensing apparatus according to a preferred embodiment of the invention is illustrated in FIGS. 1-3, and shown generally at reference numeral 10. The apparatus 10 generally comprises a motorized weed trimmer 11, and a sprayer 12. The trimmer 11 includes an arm 13 with proximal and distal ends. A weed trimmer head piece 14 is mounted at the distal end of the arm 13. The head piece 14 includes a rotatable string 15, preferably made of nylon, plastic or other suitable material, for cutting weeds and other unwanted vegetation. A motor 35 is mounted at the proximal end of the arm 13, and is operatively connected to the head piece 14 to drive the rotatable string 15. The motor 35 can be powered by gas, electricity or other suitable energy source. A handle 16 is mounted on the arm 13 proximate the proximal end.

The sprayer 12 is attached to the arm via mounting supports 17, 18. Each mounting support 17, 18 defines apertures 36 for receiving a fastener, such as a screw, that engages the arm 13. The sprayer 12 comprises a container 19 for holding a desired liquid, such as a pesticide. As used in this application, the term pesticide refers generally to all compositions used to destroy, prevent and/or control unwanted pests and/or vegetation including, but not limited to, herbicides, fungicides, and insecticides. The preferred pesticide is ROUNDUP weed killer. Furthermore, other liquid compositions having agricultural and/or botanical purposes, such as liquid fertilizers can be stored in the container 19 and used in conjunction with the invention. As shown in FIG. 1, the container 19 includes an indenture to conform around the handle 16.

The container 19 includes a first opening that communicates with an input port 20. A piston 21 is positioned within a pump tube 22 that communicates with the input port 20. A hand actuator 23 is positioned and operatively connected to the piston 21. By grasping and moving the actuator 23 back and forth the piston 21 is moved forcing air through the input port 20 and into the container 19 in order to pressurize the container 19.

As shown in FIG. 1, the container 19 includes a second opening positioned above the first opening. The second opening communicates with a discharge outlet 24. A pick-up hose 25 is positioned within the discharge outlet 24 for facilitating withdrawal of liquid from the container 19. A valve 26 is also positioned within the discharge outlet 24 for controlling the flow of liquid out of the discharge outlet 24. An elongate fluid line 27 is connected to the discharge outlet 24 at one end, and a sprayer nozzle 28 at the other end.

The length of the fluid line 27 is adjustable, however, the fluid line preferably extends a substantial length of the arm 13 to allow for the container 19 to be positioned proximate the handle 16 near the proximal end of the arm 13, and the nozzle 28 to be positioned proximate the distal end of the arm 13, as shown in FIG. 1. By positioning the container 19 proximate the handle 16, the substantial weight of the liquid filled container 19 can be more easily borne by the user and greater control can be exercised over the apparatus 10. In addition, it is preferable to position the nozzle 28 proximate the distal end of the arm 13 to provide greater accuracy in directing the spray of liquid to the desired target on the ground. Furthermore, by minimizing the distance the sprayed liquid must travel, unwanted contact between the sprayed liquid and other parts of the apparatus 10, the user and other unintended contact is prevented. As such, the elongate fluid line 27 allows for the container 19 to be positioned proximate the handle 16 and proximal end of the arm 13 to provide greater ease in carrying and handling the apparatus 10, while also enables the liquid to be dispensed proximate the distal end of the arm 13 thereby providing greater control in directing the stream of the sprayed liquid.

The valve 26 is operatively connected by a trigger link 29 to a trigger 30. Pressing the trigger 30 opens the valve 26 to allow the pressurized liquid within the container 19 to flow through the discharge outlet 24 and into the fluid line 27. The liquid flows through the fluid line 27 and is sprayed out of the nozzle 28.

Preferably, the nozzle 28 is positioned on the arm 13 in a direction opposite to the head piece 14, at an angle of approximately 100 to 120 degrees. By positioning the nozzle 28 this way the liquid sprayed from the nozzle 28 does not contact the head piece 14, and most importantly, the string 15. As such, pesticide is not unintentionally spread onto areas that the user does not want pesticide.

The container 19 has a third opening that is covered by fill cap 31. The fill cap 31 is held on the container 19 by threaded engagement or other appropriate means. To fill the container 19 with the desired liquid, the fill cap 31 is removed and the liquid is poured through the third opening. Preferably, the container holds thirty-two ounces.

The apparatus includes a trigger handle 32 positioned under the container 19. The trigger handle 32 defines a chamber 33 in which the trigger 30 is positioned. A trigger guard 34 is positioned midway through the chamber 33 and provides a structure on which the user rests his finger to prevent unintentional engagement of the trigger 30.

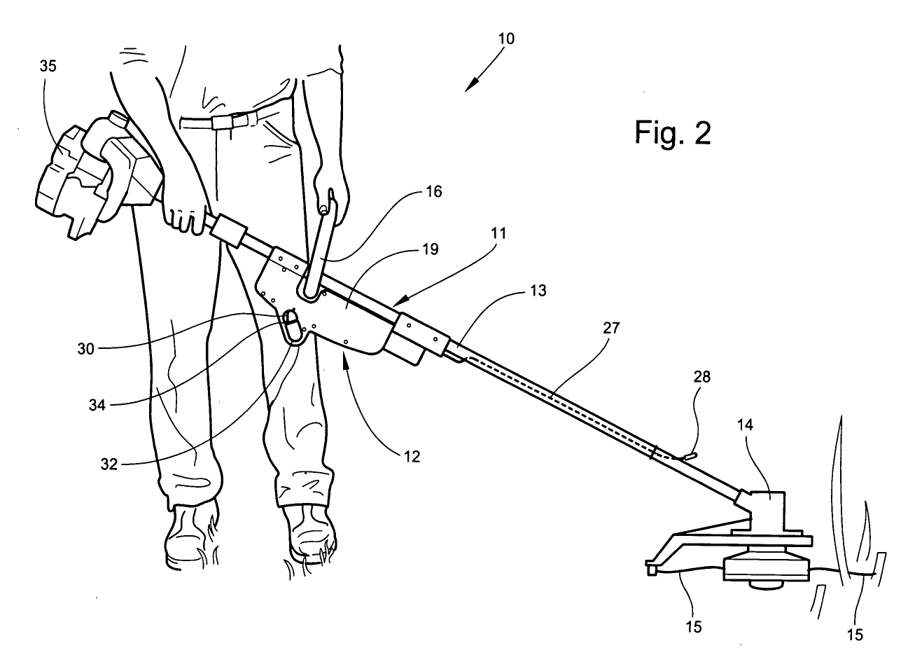

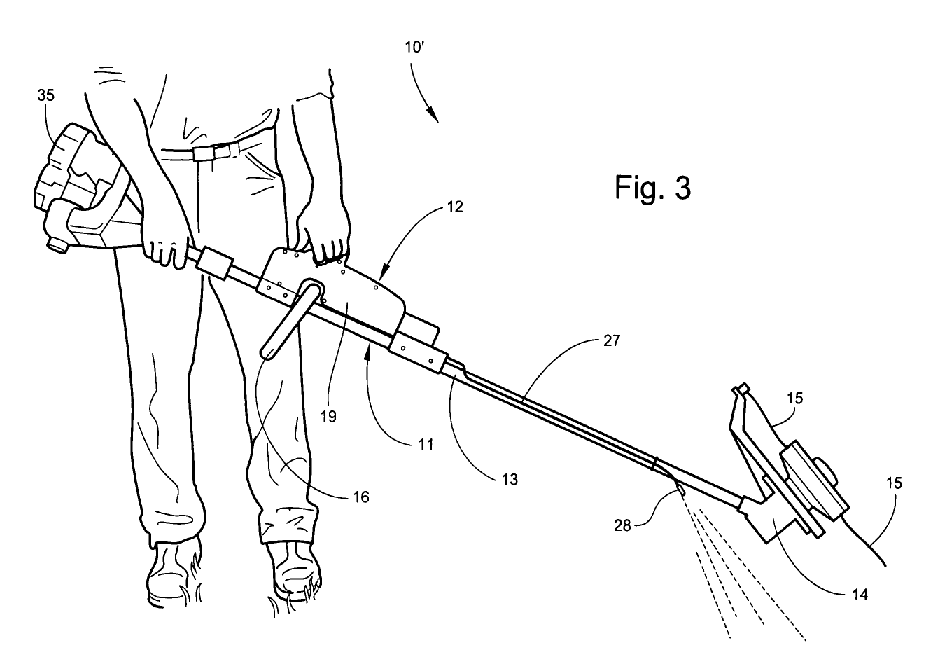

As shown in FIGS. 2 and 3, the apparatus 10 is operable in two modes—a lawn maintenance mode and a liquid dispensing mode. When operated in lawn maintenance mode, as shown in FIG. 2, the user positions the apparatus 10 with the head piece 14 positioned to the vegetation he desires to trim, and operates the apparatus 10 just like a conventional motorized weed trimmer by engaging the motor that rapidly rotates the string 15 which cuts the desired vegetation. When the user desires to dispense a liquid, such as a pesticide, herbicide or fertilizer, in a certain area, the apparatus 10 is switched to the liquid dispensing mode by rotating the apparatus 10 approximately 180 degrees such that the angled nozzle 28 is directed toward the ground, and the head piece 14 is pointed away from the ground, as shown in FIG. 3. The user rests his finger on the trigger guard 34 to avoid unintentional engagement of the trigger while rotating the apparatus 10. Once the apparatus has been rotated, the user removes his finger from the trigger guard 34 and engages the trigger 30 to dispense the liquid as desired. When the user desires to return to the lawn maintenance mode, the apparatus 10 is rotated 180 degrees back to its original position, shown in FIG. 2.

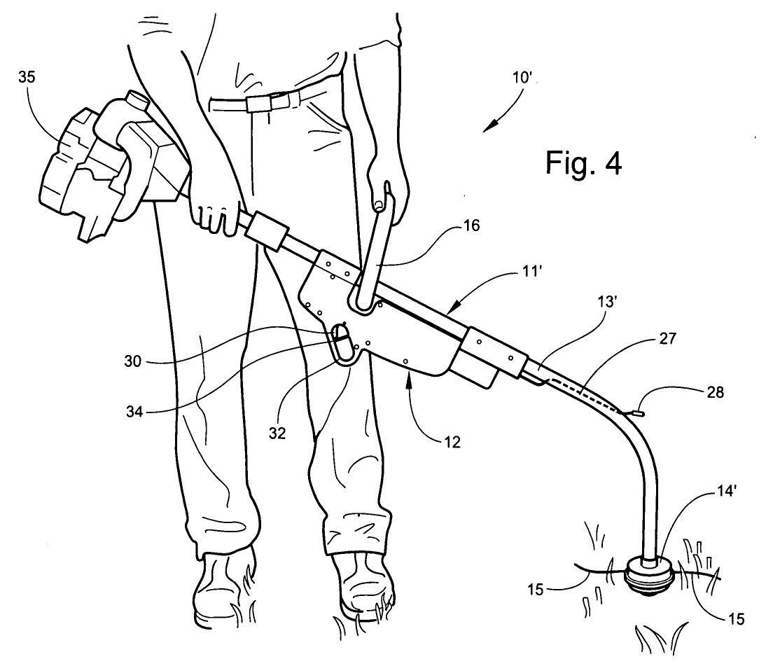

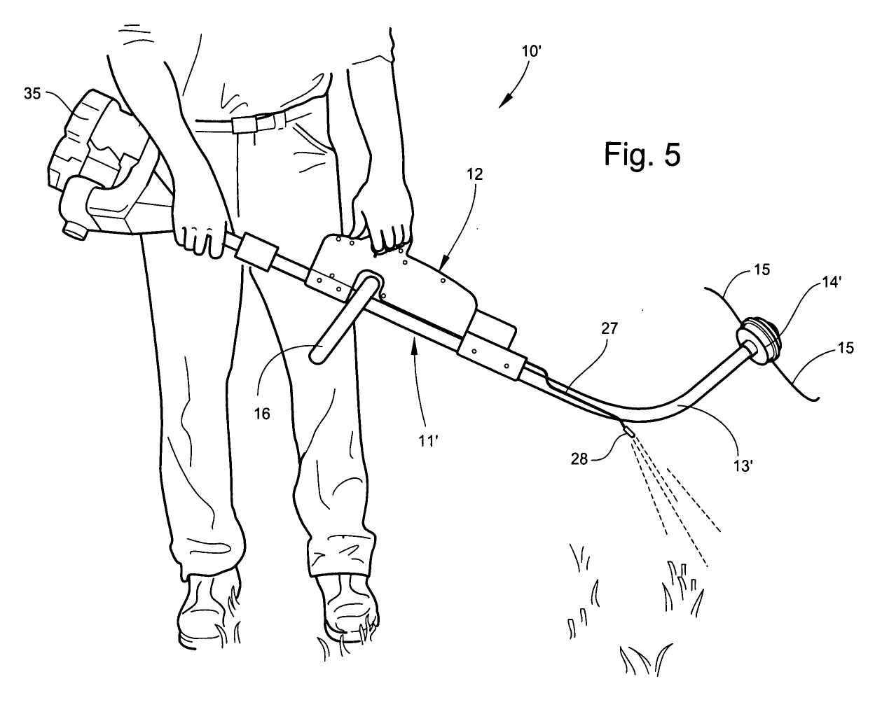

Another preferred embodiment of the invention is illustrated in FIGS. 4 and 5, and shown generally at reference numeral 10′. The apparatus 10′ is the same in all significant aspects as the previously described embodiment, apparatus 10, except that apparatus 10′ includes an alternative weed trimmer 11′ having an arm 13′ that is bent in a bow shape typical of weed trimmers that are sold and marketed as consumer or household trimmers. Accordingly, the same reference numerals have been retained to denote those features that are the same in both apparatus 10 and apparatus 10′. Apparatus 10′ is used in the same manner as that disclosed above for apparatus 10.

Yet another preferred embodiment of the invention is illustrated in FIG. 5, and shown generally at reference numeral 10″. The apparatus 10″ is the same in all significant aspects as previously described embodiment apparatus 10, except that apparatus 10″ is adapted for use as an edger, instead of the previously disclosed weed trimmer. Accordingly, the same reference numerals have been retained to denote those features that are the same in both apparatus 10 and apparatus 10″. The apparatus 10″ includes a head piece 14″ comprising an edging device. The edging device 45 is driven by the motor 35. The apparatus 10″ is operated in a similar manner as apparatus 10 disclosed above.

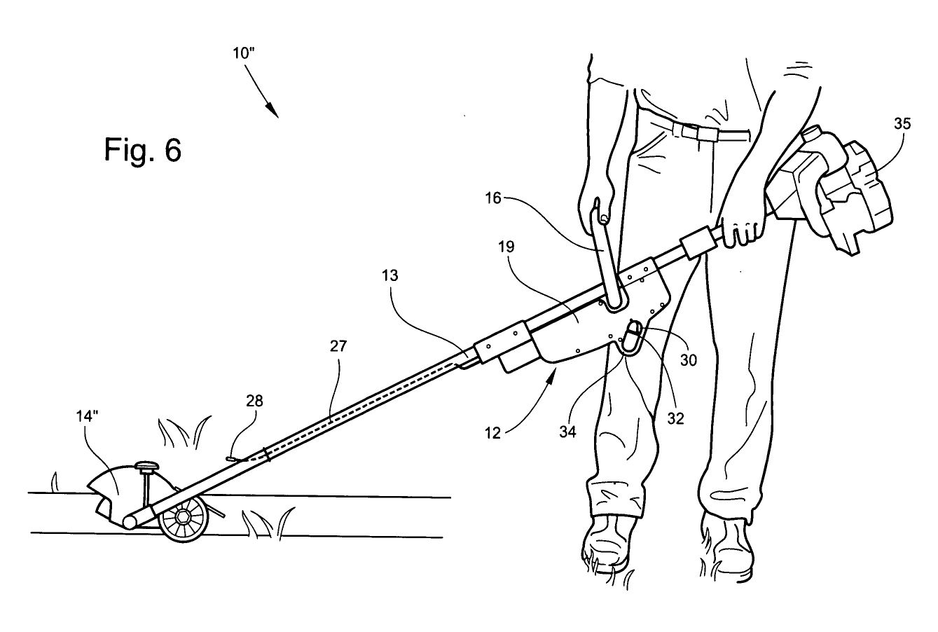

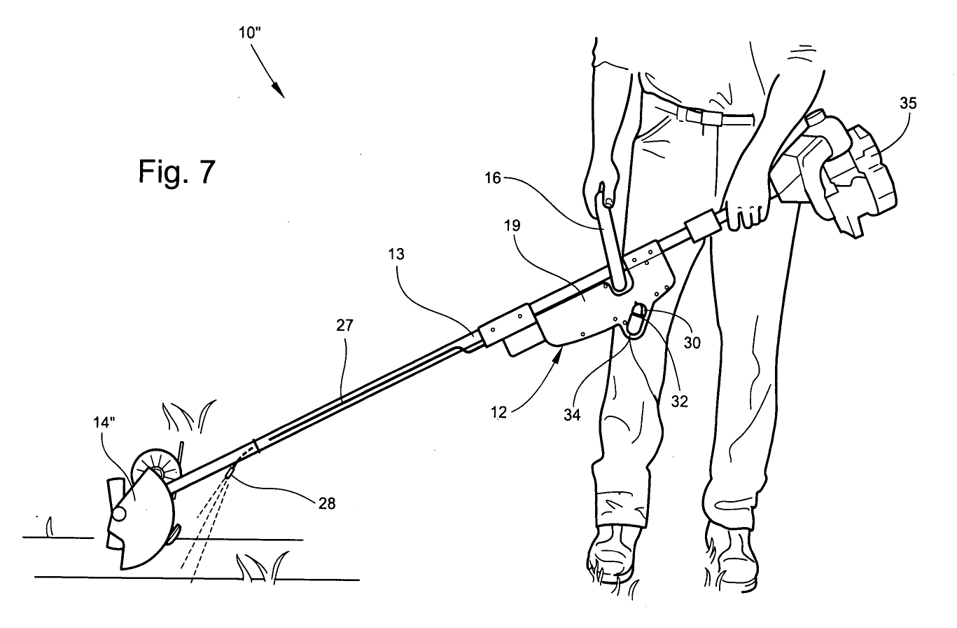

As shown in FIGS. 6 and 7, the apparatus 10 is operable in two modes—a lawn maintenance mode and a liquid dispensing mode. When operated in lawn maintenance mode, as shown in FIG. 6, the user positions the apparatus 10″ with the head piece 14″ positioned to the area of the ground that is intended to be edged, and operates the apparatus 10″ just like a conventional motorized edger by engaging the motor that rotates the edging device 45 which cuts the edges the ground. When the user desires to dispense a liquid, such as a pesticide, herbicide or fertilizer, in a certain area, the apparatus 10″ is switched to the liquid dispensing mode by rotating the apparatus 10″ approximately 180 degrees such that the angled nozzle 28 is directed toward the ground, and the head piece 14″ is pointed away from the ground, as shown in FIG. 7. The user rests his finger on the trigger guard 34 to avoid unintentional engagement of the trigger while rotating the apparatus 10″. Once the apparatus has been rotated, the user removes his finger from the trigger guard 34 and engages the trigger 30 to dispense the liquid as desired. When the user desires to return to the lawn maintenance mode, the apparatus 10″ is rotated 180 degrees back to its original position, shown in FIG. 6.

In yet another alternative embodiment of the invention, the sprayer 12 described above is mounted on a back-pack blower. The blower replaces the weed trimmer or edger, and operates in a similar manner as described above.

A lawn maintenance and liquid dispensing apparatus and method of using same is described above. Various details of the invention may be changed without departing from its scope. Furthermore, the foregoing description of the preferred embodiments of the invention and the best mode for practicing the invention are provided for the purpose of illustration only and not for the purpose of limitation—the invention being defined by the claims.

I claim:

1. An apparatus for lawn maintenance and dispensing a liquid comprising:
(a) a motorized lawn maintenance tool including an arm having first and second ends and a head piece connected proximate the first end of the arm; and
(b) a spraying device connected to the arm for spraying a liquid, the spraying device comprising a container for holding the liquid and a nozzle for spraying the liquid, wherein the nozzle is positioned at an angle relative to the arm whereby liquid dispensed from the nozzle is directed away from the head piece.

2. An apparatus according to claim 1, wherein the motorized lawn maintenance tool is selected from the group consisting of a weed trimmer, an edger, and a leaf blower.

3. An apparatus according to claim 1, wherein the lawn maintenance tool comprises a weed trimmer, and wherein the weed trimmer includes a rotatable string for trimming vegetation.

4. An apparatus according to claim 3, wherein the liquid exiting the nozzle avoids contacting the string.

5. An apparatus according to claim 1, wherein the motorized lawn maintenance tool includes a motor positioned proximate the second end of the arm.

6. An apparatus according to claim 1, wherein the arm is bent wherein the arm is ergonomically formed to define a bow shape.

7. An apparatus according to claim 1, further comprising a handle connected to the arm and positioned proximate the second end of the arm.

8. An apparatus according to claim 7, wherein the container is positioned proximate the handle, and the nozzle is positioned proximate the first end of the arm.

9. An apparatus according to claim 1, wherein the liquid comprises a pesticide.

10. An apparatus according to claim 1, wherein the nozzle is positioned at an angle of 100 to 120 degrees relative to the arm.

11. An apparatus according to claim 1, wherein the apparatus is manually rotatable between a lawn maintenance mode with the lawn maintenance tool in operation and a liquid dispensing mode with the liquid being sprayed from the nozzle.

12. An apparatus according to claim 11, wherein the apparatus is rotated approximately 180 degrees when rotated between the lawn maintenance mode and the liquid dispensing mode.

13. An apparatus according to claim 11, further comprising a trigger operatively connected to a valve positioned in the fluid line whereby pressing the trigger opens the valve to allow the liquid to pass through the fluid line.

13. An apparatus according to claim 12, further comprising a trigger guard positioned over the trigger for positioning a finger of a user when rotating the apparatus from the lawn maintenance mode to the liquid dispensing mode whereby unintentional spraying of the liquid is prevented.

15. An apparatus according to claim 1, wherein the spraying device further comprises a pump connected to the container for pressurizing the container, and a fluid line connected to the container and the nozzle, wherein the liquid in the container is delivered through the fluid line and exits the nozzle, whereby the nozzle is positionable proximate the first end of the arm and the container is positionable proximate the second end of the arm.

16. A method of lawn maintenance comprising:
(a) providing an apparatus comprising:
(i) a lawn maintenance tool selected from the group consisting of a weed trimmer and an edger, the tool including an arm having first and second ends and a head piece connected proximate the first end of the arm,
(ii) a spraying device connected to the arm for spraying a liquid, the spraying device comprising a nozzle positioned at an angle relative to the arm whereby liquid dispensed from the nozzle is directed away from the head piece, and
(iii) wherein the apparatus is operable in a lawn maintenance mode with the lawn maintenance tool in operation and a liquid dispensing mode with the liquid being sprayed from the nozzle, and further wherein the apparatus is rotatable between a first position for operation in the lawn maintenance mode and a second position for operation in the liquid dispensing mode;
(b) operating the lawn maintenance apparatus in the lawn maintenance mode wherein the lawn maintenance tool is utilized to perform a desired lawn maintenance function;
(c) rotating the lawn maintenance apparatus between the first position and the second position; and
(d) operating the lawn maintenance apparatus in the liquid dispensing mode wherein liquid is dispensed at a desired location.

17. A method of lawn maintenance according to claim 16, wherein the lawn maintenance apparatus comprises a trigger operatively connected to the nozzle whereby pressing the trigger actuates the flow of the liquid through the nozzle, and a trigger guard positioned over the trigger, and further comprising the step of positioning a finger of a user on the trigger guard when rotating the lawn maintenance apparatus from the first position to the second position whereby unintentional spraying of the liquid is prevented.

18. A method of lawn maintenance according to claim 16, wherein the nozzle is positioned at an angle of 100 to 120 degrees relative to the arm.

19. A method of lawn maintenance according to claim 16, wherein the step of rotating the lawn maintenance apparatus from the first position to the second position comprises rotating the lawn maintenance apparatus approximately 180 degrees.

20. A method of lawn maintenance according to claim 16, wherein the lawn maintenance tool comprises a weed trimmer, and the step of operating the lawn maintenance apparatus in the lawn maintenance mode comprises cutting away unwanted vegetation.
